(19) United States
(12) Patent Application Publication
(10) Pub. No.: US 2010/0005100 A1
(43) Pub. Date: Jan. 7, 2010

(54) DATA MANAGEMENT SYSTEM AND METHOD

(76) Inventors: Michael Callahan, Marblehead, MA (US); Marc N. Teal, Dracut, MA (US); Brian Madden, Plymouth, MA (US)

Correspondence Address: HOLLAND & KNIGHT LLP, 10 ST. JAMES AVENUE, BOSTON, MA, 02116-3889, US

(21) Appl. No.: 12/488,002

(22) Filed: Jun. 19, 2009

Related U.S. Application Data
(60) Provisional application No. 61/073,969, filed on Jun. 19, 2008.
(60) Provisional application No. 61/073,960, filed on Jun. 19, 2008.
(60) Provisional application No. 61/073,957, filed on Jun. 19, 2008.

(51) Int. Cl. G06F 17/30

(52) U.S. Cl. 707/10; 707/104.1; 707/E17.107

(57) ABSTRACT

A system, computer-implemented method, and a computer program product for defining a plurality of rental properties within a reporting datastore. A report template is defined and data is extracted from the reporting datastore. At least a portion of the report template is populated with at least a portion of the data extracted from the reporting datastore.

This application claims the benefit of the following provisional patent applications, each of which is herein incorporated by reference in their entirety: U.S. Ser. No. 61/073,969, filed on 19 Jun. 2008; U.S. Ser. No. 61/073,960, filed on 19 Jun. 2008; and U.S. Ser. No. 61/073,957, filed on 19 Jun. 2008.

### TECHNICAL FIELD

This disclosure relates to data management and, more particularly, to rental property data management.

### BACKGROUND

Databases are often utilized in enterprise environments to store and organize data. An example of such a database is a database that defines rental property data. Data management systems are often utilized with such databases to allow the user to interpret the data stored within the database.

Oftentimes, the type of reports that are available to the user may be limited to a few report templates that were designed by the people that created the database. One reason for such a limited selection of available report templates may be due to the complexity of accessing the raw data included within the database.

### SUMMARY OF DISCLOSURE

In a first implementation, a data management system includes a reporting datastore configured to define a plurality of rental properties. A report definition process is configured to allow a user to define a report template. A report population process is configured to extract data from the reporting datastore and populate at least a portion of the report template with at least a portion of the data extracted from the reporting datastore.

One or more of the following features may be included. The reporting datastore may be a rental property database. The rental property database may be configured to define a plurality of data records that identify at least one rental property. The report definition process may include a report template editor that allows the user to define the report template. The report template editor may be configured to allow the user to modify the report template. The report template editor may be configured to allow the user to modify a premade report template chosen from a plurality of premade report templates. A backend datastore system, from which data may be extracted to populate the reporting datastore, may be coupled to the reporting datastore.

In another implementation, a computer-implemented method includes defining a plurality of rental properties within a reporting datastore. A report template is defined and data is extracted from the reporting datastore. At least a portion of the report template is populated with at least a portion of the data extracted from the reporting datastore.

One or more of the following features may be included. The reporting datastore may be a rental property database. The rental property database may be configured to define a plurality of data records that identify at least one rental property. Defining a report template may include defining a report template with a report template editor. The report template editor may be further configured to allow the user to modify the report template. The report template editor may be further configured to allow the user to modify a premade report template chosen from a plurality of premade report templates. A backend datastore system, from which data may be extracted to populate the reporting datastore, may be coupled to the reporting datastore.

In another implementation, a computer program product resides on a computer readable medium that has a plurality of instructions stored on it. When executed by a processor, the plurality of instructions cause the processor to perform operations including defining a plurality of rental properties within a reporting datastore. A report template is defined and data is extracted from the reporting datastore. At least a portion of the report template is populated with at least a portion of the data extracted from the reporting datastore.

One or more of the following features may be included. The reporting datastore may be a rental property database. The rental property database may be configured to define a plurality of data records that identify at least one rental property. Defining a report template may include defining a report template with a report template editor. The report template editor may be further configured to allow the user to modify the report template. The report template editor may be further configured to allow the user to modify a premade report template chosen from a plurality of premade report templates. A backend datastore system, from which data may be extracted to populate the reporting datastore, may be coupled to the reporting datastore.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a data management process coupled to a distributed computing network; and

FIG. 2 is a flowchart of the data management process of FIG. 1.

Like reference symbols in the various drawings indicate like elements.

### DETAILED DESCRIPTION OF THE PREFERRED EMBODIMENTS

### System Overview:

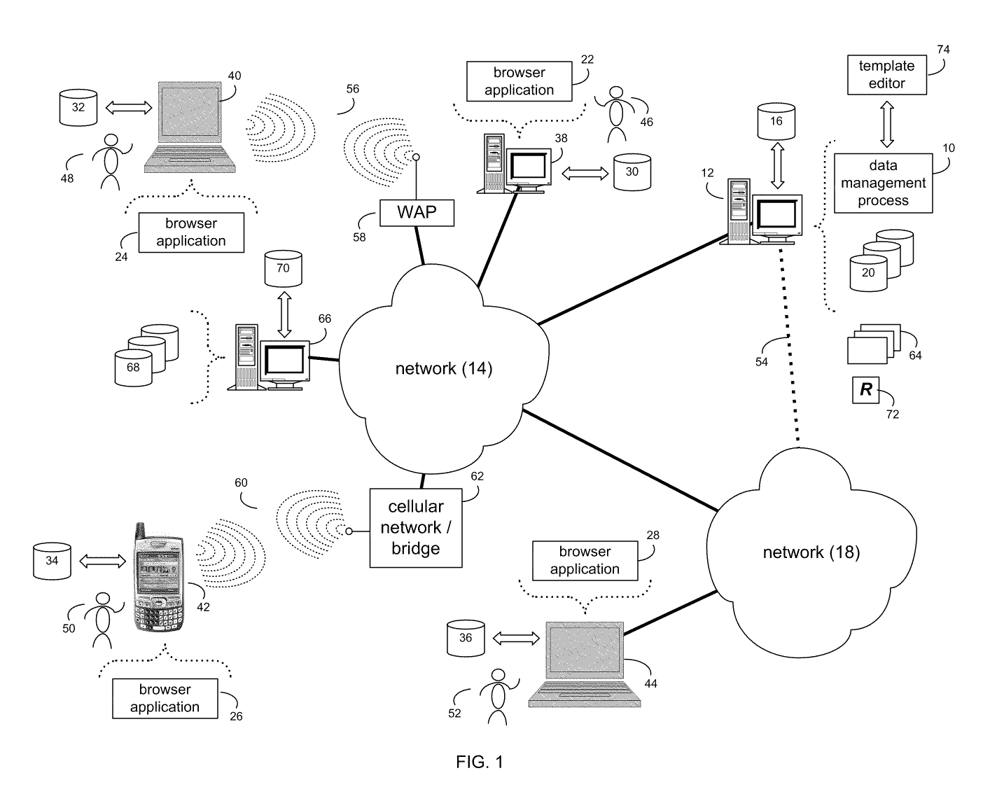

Referring to FIG. 1, there is shown data management process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example.

As will be discussed below in greater detail, data management process 10 may define a plurality of rental properties within a reporting datastore. A report template may be defined and data may be extracted from the reporting datastore. At least a portion of the report template may be populated with at least a portion of the data extracted from the reporting datastore.

The instruction sets and subroutines of data management process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: IBM WebSphere™, Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute reporting datastore 20, examples of which may include but are not limited to databases produced by Microsoft and Oracle. Reporting datastore 20 may allow for an organization to store, manage, and access data stored within the datastore. One non-limiting example of such data may include but is not limited to data concerning rental properties. For example, database records may be generated that identify various rental properties and information concerning such rental properties (e.g., the identity of the owner of the rental property, the purchase price of the rental property, the tax liability of the rental property, and the income generated by the rental property, for example). Reporting datastore 20 may be a stand alone application that interfaces with data management process 10 or an applet/application that is executed within data management process 10.

The instruction sets and subroutines of reporting datastore 20, which may be stored on storage device 16 coupled to server computer 12, may be executed by one or more processors (not shown) and one or more memory architectures (not shown) incorporated into server computer 12.

The instruction sets and subroutines of browser applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a server (not shown), a data-enabled, cellular telephone (not shown), and a dedicated network device (not shown). Using browser applications 22, 24, 26, 28, users 46, 48, 50, 52 (respectively) may access data management process 10 and may define one or more report templates that may be populated with data extracted from reporting datastore 20.

Users 46, 48, 50, 52 may access data management process 10 directly through the device on which the browsing application (e.g., browsing applications 22, 24, 26, 28) is executed, namely client electronic devices 38, 40, 42, 44, for example. Users 46, 48, 50, 52 may access data management process 10 directly through network 14 or through secondary network 18. Further, server computer 12 (i.e., the computer that executes data management process 10) may be connected to network 14 through secondary network 18, as illustrated with link line 54 (shown in phantom).

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

For the following discussion, browser application 22 is going to be described for illustrative purposes. However, this is not intended to be a limitation of this disclosure, as other browsing applications (e.g., browsing applications 24, 26, 28) may be equally utilized.

Assume for illustrative purposes that data management process 10 includes reporting datastore 20 that defines a plurality of database records 64 that identify various rental properties and information concerning such rental properties. Further, assume that server computer 66 may execute a backend datastore system (e.g., backend datastore 68) that may be coupled to data management process 10. Data may be extracted from backend datastore 68 and used to populate reporting datastore 20. Examples of backend datastore 68 may include but are not limited to databases produced by Microsoft and Oracle.

The instruction sets and subroutines of backend datastore 68, which may be stored on storage device 70 coupled to server computer 66, may be executed by one or more processors (not shown) and one or more memory architectures (not shown) incorporated into server computer 66.

While backend datastore 68 is shown to be a single datastore, this is for illustrative purposes only and is not intended to be a limitation of this disclosure, as other configurations are possible. For example, backend datastore 68 may include a plurality of individual datastores, examples of which may include but are not limited to an investor database, and a document management database. Additionally, while server computer 66 is shown to be a single server, this is for illustrative purposes only and is not intended to be a limitation of this disclosure, as other configurations are possible. For example, server computer 66 may include a plurality of individual server computers, examples of which may include but are not limited to an investor server computer, and a document management server computer.

### The Data Management Process:

As stated above and as will be discussed below in greater detail, data management process 10 may define a plurality of rental properties within a reporting datastore. A report template may be defined and data may be extracted from the reporting datastore. At least a portion of the report template may be populated with at least a portion of the data extracted from the reporting datastore.

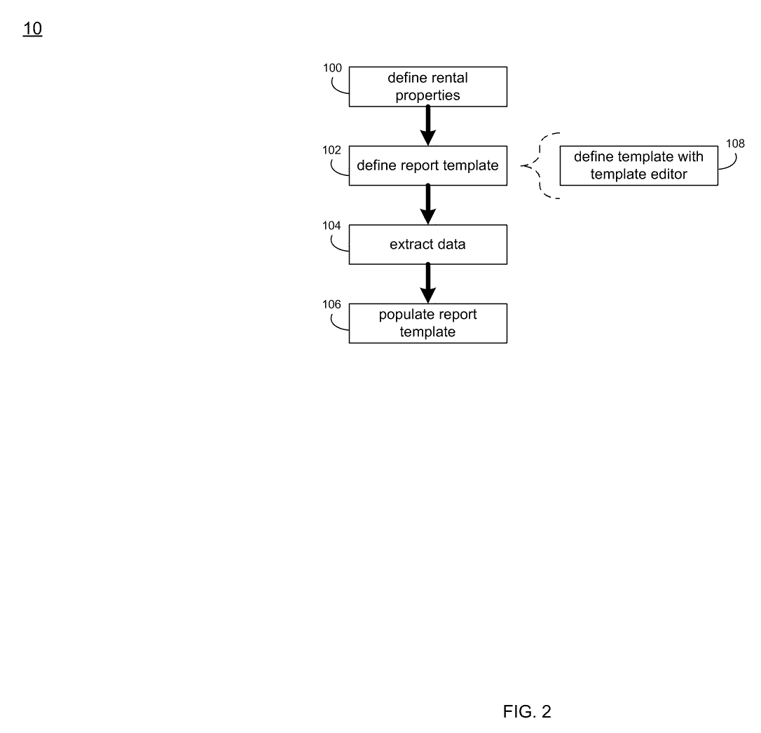

Referring also to FIG. 2, data management process 10 may allow a user to define 100 a plurality of rental properties within reporting datastore 20. For example, user 46 may directly define 100 one or more rental properties within reporting datastore 20 via e.g., browser application 22 executed on personal computer 38.

Alternatively, user 46 may directly define 100 one or more rental properties within backend datastore 68 via e.g., browser application 22 executed on personal computer 38. At least a portion of the data (e.g., concerning the rental properties) included within backend datastore 68 may be extracted from backend datastore 68 and used to populate reporting datastore 20 (which, as discussed above, may be coupled to backend datastore 68). Accordingly, an independent copy (or a portion thereof) of the data included within backend datastore 68 may be maintained within reporting datastore 20. Therefore, data management process 10 need not have access to backend datastore 68 and may only need access to reporting datastore 20. Further, as at least a portion of the data (e.g., concerning the rental properties) included within backend datastore 68 may be extracted from backend datastore 68 and used to populate reporting datastore 20, the structure of backend datastore 68 need not be known/understood by user 46, as only the algorithm/process (not shown) used to extract data from backend datastore 68 and populate reporting datastore 20 needs to know/understand the structure of backend datastore 68.

Once the plurality of rental properties is defined 100 within reporting datastore 20 (i.e., either by direct entry or extraction from backend datastore 68), report template 72 may be defined 102 and data may be extracted 104 from reporting datastore 20. At least a portion of report template 72 may be populated 106 with at least a portion of the data extracted from reporting datastore 20.

For example, suppose that user 46 managed many properties and wanted to define a report that displayed (among other things) the total expenses associated with a specific rental property (or a group of specific rental properties) for a given tax year versus the total revenue realized from that specific rental property (or that group of specific rental properties) for that given tax year. Using data management process 10, user 46 may define 102 a report template that (once populated 106) would allow user 46 to see the requested information.

Data management process 10 may include report template editor 74 that may assist user 46 in the definition 102 of report template 72. An example of report template editor 74 may include but is not limited to Crystal Reports, which is available from SAP AG of Walldorf, Germany. Once report template 72 is defined using data management process 10 and/or report template editor 74, report template 72 may be populated 106 in accordance with the reporting criteria defined by user 46. Accordingly, user 46 may e.g., define 102 report temple 72 so that report template 72 is populated 106 to identify only those rental properties in which expenses exceed revenue for a given tax year. Alternatively, user 46 may e.g., define 102 report temple 72 so that report template 72 is populated 106 to identify only those rental properties in which revenue exceeds expenses for a given tax year. Alternatively still, user 46 may e.g., define 102 report temple 72 so that report template 72 is populated 106 to identify all rental properties (regardless of whether expenses exceed revenue or revenue exceeds expenses for a given tax year).

While data management process 10 is described above as including report template editor 74 that allows for the definition 102 of e.g., report template 72, this is for illustrative purposes only and is not intended to be a limitation of this disclosure, as other configuration are possible and are considered to be within the scope of this disclosure. For example, report template editor 74 may be further configured to allow the user to modify an existing report template (e.g., modify previously-created report template 72). Accordingly, once user 46 defines 102 report template 72, user 46 may subsequently modify report template 72 using report template editor 74.

Additionally, report template editor 74 may be further configured to allow e.g., user 46 to modify a premade report template (not shown) chosen from a plurality of premade report templates (not shown). For example, data management process 10 and/or report template editor 74) may be preconfigured to include a plurality of general purpose templates (not shown). User 46 may use report template editor 74 to modify one or more of the plurality of general purpose templates (not shown) to generate a customized template (not shown) that is useful to user 46.

A number of implementations have been described. Nevertheless, it will be understood that various modifications may be made. Accordingly, other implementations are within the scope of the following claims.

What is claimed is:

1. A data management system comprising:
a reporting datastore configured to define a plurality of rental properties;
a report definition process configured to allow a user to define a report template; and
a report population process configured to extract data from the reporting datastore and populate at least a portion of the report template with at least a portion of the data extracted from the reporting datastore.

2. The data management system of claim 1 wherein the reporting datastore is a rental property database.

3. The data management system of claim 2 wherein the rental property database is configured to define a plurality of data records that identify at least one rental property.

4. The data management system of claim 1 wherein the report definition process includes a report template editor that allows the user to define the report template.

5. The data management system of claim 4 wherein the report template editor is configured to allow the user to modify the report template.

6. The data management system of claim 4 wherein the report template editor is configured to allow the user to modify a premade report template chosen from a plurality of premade report templates.

7. The data management system of claim 1 further comprising:
a backend datastore system, coupled to the reporting datastore, from which data is extracted to populate the reporting datastore.

8. A computer-implemented method comprising:
defining a plurality of rental properties within a reporting datastore;
defining a report template;
extracting data from the reporting datastore; and
populating at least a portion of the report template with at least a portion of the data extracted from the reporting datastore.

9. The computer-implemented method of claim 8 wherein the reporting datastore is a rental property database.

10. The computer-implemented method of claim 9 wherein the rental property database is configured to define a plurality of data records that identify at least one rental property.

11. The computer-implemented method of claim 8 wherein defining a report template includes defining a report template with a report template editor.

12. The computer-implemented method of claim 11 wherein the report template editor is further configured to allow the user to modify the report template.

13. The computer-implemented method of claim 11 wherein the report template editor is further configured to allow the user to modify a premade report template chosen from a plurality of premade report templates.

14. The computer-implemented method of claim 8 further comprising:
coupling a backend datastore system to the reporting datastore, wherein data is extracted from the backend datastore system to populate the reporting datastore.

15. A computer program product residing on a computer readable medium having a plurality of instructions stored thereon, which, when executed by a processor, cause the processor to perform operations comprising
defining a plurality of rental properties within a reporting datastore;
defining a report template;
extracting data from the reporting datastore; and
populating at least a portion of the report template with at least a portion of the data extracted from the reporting datastore.

16. The computer program product of claim 15 wherein the reporting datastore is a rental property database.

17. The computer program product of claim 16 wherein the rental property database is configured to define a plurality of data records that identify at least one rental property.

18. The computer program product of claim 15 wherein the instructions for defining a report template include instructions for defining a report template with a report template editor.

19. The computer-implemented method of claim 18 wherein the report template editor is further configured to allow the user to modify the report template.

20. The computer-implemented method of claim 18 wherein the report template editor is further configured to allow the user to modify a premade report template chosen from a plurality of premade report templates.

21. The computer-implemented method of claim 15 further comprising instructions for:
coupling a backend datastore system to the reporting datastore, wherein data is extracted from the backend datastore system to populate the reporting datastore.
